(19) United States
(12) Patent Application Publication
(10) Pub. No.: US 2006/0070063 A1
(43) Pub. Date: Mar. 30, 2006

(54) Application sets install method for dispersion server

(76) Inventors: Souichi Takashige, Yokohama (JP); Shigeru Miyake, Tokyo (JP); Takeshi Ishizaki, Yokohama (JP); Hideki Takano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/062,877

(22) Filed: Feb. 23, 2005

(30) Foreign Application Priority Data
Sep. 29, 2004 (JP) 2004-283024

(51) Int. Cl. G06F 9/445

(52) U.S. Cl. 717/174

(57) ABSTRACT

A computer system is composed of a plurality of hosts and provides a sole function. The computer system includes software packages over the hosts, those software packages often depending upon each other. The computer system predefines a name to be read by a person and to be usable according to a function of each host computer and describes a dependency among the software packages across the plural hosts through the use of the name. When installing the software package, the computer system corresponds a name that represents a general-purpose function with a real host in the target host, recursively execute a process of automatically determining the destination host to which the software package is to be installed.

### INCORPORATION BY REFERENCE

The present application claims priority form Japanese application P2004-283024 filed on Sep. 29, 2004, the content of which is hereby incorporated by reference into this application.

### BACKGROUND OF THE INVENTION

The present invention relates to an application sets install method for dispersion server.

For configuring a computer system for running a specific operation, it is necessary to distribute and install a plurality of software programs running on an operating system (OS). The software program hardly completes its function as a sole unit but often depends on another software program or library.

For the purpose of facilitating management of the install and update of the software programs depending upon each other in a computer system having complicated dependencies among the software programs, it is common to use a software management mechanism.

Techniques disclosed in JP-A-10-83280 have proposed a function of searching a dependency of software programs on each other in a sole computer and automatically installing the software programs that are dependent on each other as a basic function of the software management mechanism. In the case of installing a software program A, the foregoing invention is arranged to automatically install and update a software program B on which the software program A depends.

In a computer system configured of a plurality of physical host computers each of which performs a process run by the OS dependently on the computer, (each of the host computers being basically referred simply to as a host), the dependency of the software programs upon each other often ranges over a plurality of computers. (In the following description, it is assumed that the computer system is configured of one or more hosts.) For example, a database system is required to install the software programs having respective functions to the host for a server processing and the host for a client processing, those software programs depending upon each other.

Techniques disclosed in JP-A-2001-175460 have proposed a software management mechanism that guarantees a dependency of the software programs upon each other over a plurality of computers in the computer system. The software management mechanism searches whether or not a software program B depending upon a software program A has been already installed in the computer system before installing the software program A. If a host in which the software program B has been installed is found, the mechanism records the dependency of the software program A upon the software program B installed in the host and then installs the software program A. If the software program B depending upon the software program A is not installed, according to an instruction given by a software administrator, the mechanism waits for an install of the software program B and then installs the software program A. In the case of installing the software program B depending upon the software program A, the foregoing process is recursively repeated so that the mechanism may guarantee the install of the software program A after all the dependent software programs have been installed.

For a computer system configured of a plurality of hosts, it is quite difficult to select a proper software program and determine a proper host to which the software program is to be installed.

Basically, it is preferable that a creator of each software package describes a hint of selecting a proper software program and determining a proper host to which the selected software program is to be installed by referring to dependency among the software programs, based on a knowledge and know-how to the created software package and then supplies a software administrator with the software package. However, the prior art has no method of generally describing the dependency. Hence, the software administrator has been required to determine a proper host to which each of the administrated software packages is to be installed.

When the software administrator determines a proper destination to which each of all the administrated software packages is to be installed, the software administrator is required to grasp the method of determining a proper host to which each of the administrated software packages is to be installed. For determining the proper host to which each software package is to be installed, it is often necessary to have a sufficient knowledge of a know-how proper to each software package. It means that determination of a proper destination to which each software package is to be installed gives a heavy burden to the software administrator. (Hereafter, throughout the specification, the software package or program will be often referred simply to as the software.) With respect to the burden given in determining the installing destination, the following problems the prior arts did not consider are found.

(1) Absence of a Function of Aiding in Determining a Destination Host to which the Software is to be Installed

Though the work of determining a proper host to which each of all the softwares in the computer system is to be installed gives a heavy burden to a software administrator, the prior arts do not consider the method of aiding in determining the installing destination.

In the techniques of JP-A-10-83280, the software management mechanism is merely capable of describing a dependency of the softwares closed in one host. For managing the computer system configured of a plurality of hosts, therefore, a software administrator is required to determine a proper host to which each software is to be installed one by one and explicitly install each software into the proper host.

In JP-A-2001-175460, techniques provide a system of describing dependency over a plurality of hosts and guarantees installation of the software A only if the dependency of the software A is met. If the software B depending upon the software A is not installed in the proper host, the techniques do not suggest the concrete method of aiding in determining a proper host to which the software B dependent upon the software A is to be installed. In their embodiments, a software administrator is required to determine a proper installing destination as well.

(2) Absence of Reusability of Information about a Host on which a Source Host Depends (Referred Simply to as a Dependent Host of the Source Host)

In JP-A-2001-175460, a dependency is represented by a combination of an ID for uniquely specifying a dependent host and an ID for uniquely specifying a dependent software. Hence, in a system having the different number of hosts and the different IDs assigned to the hosts from the previously defined system, the previously defined dependency of a dependent host is not reusable. It means the dependency of each host is required to be defined again. Since the system configurations including the host IDs are basically different from each other, substantially, in the foregoing system, the system administrator is required to redefine a dependency in each system. Hence, it is difficult to reuse the dependencies of the previously configured computer system.

(3) Absence of Means for Supplying Information Grasped by a Software Package Creator and a System Designer

In general, a software package creator or a system designer often has a know-how about his/her concerned software and means for determining a proper installing destination. The foregoing prior arts do not have means of describing the know-how as objective information. Hence, for describing the know-how, it is necessary to describe a system configuration as a list or as a manual with notes about installs so that a system administrator may interpret the list or the manual when installing the softwares. That is, the software administrator is required to share the same know-how with the software package creator.

It is an object of the present invention to provide a system of describing a dependency among softwares in a reusable format and easily specifying a host computer to which each software is to be installed at a batch with a simple indication, for the purpose of reducing a burden given when a software administrator determines several matters about each software included in each computer system.

### SUMMARY OF THE INVENTION

In carrying out the object in a preferred manner, according to an aspect of the invention, an application sets install method for dispersion server includes the steps of describing a dependency over a plurality of hosts configuring a system as data in a reusable format and causing each host to autonomously and recursively refer to a dependency for determining an installing destination when executing an install and to automatically execute the installing process.

The application sets install method for dispersion server includes the steps of assigning a name label of an operation host function represented as a name to be understood by a user to each host included in the system and locating an agent for managing installs in each host. Each agent has a function of referring to the correspondence between the host included in the system and the name label of the operation host function and a function of retrieving a list of hosts corresponded with a name label of a certain operation host function.

Each agent also has a function of automatically determining a software package required to be installed and a host to which the software is to be installed by referring information about a dependency of the softwares and the name label of the operation host function of each host included in the system. Further, each agent has a means of retrieving the software package, a function of requiring a dependent host of installing the software package and a function of executing the install. Actually, each agent executes the installing process required by each host.

(1) Provision of a Method of Automatically Solving a Host to which a Software is to be Installed

The application sets install for dispersion server is executed to automatically refer to and determine mapping of an abstract function name to a concrete host since information for determining a dependent host in an abstract format is written in the dependency. This makes it possible to automatically configure the overall system unless a system administrator specifies a detailed software configuration for each host.

(2) Provision of a Highly Usable Describing Method

The dependency over a plurality of hosts may be hierarchically described in a format dependent on information (such as a host name, a number of hosts and a network address) proper to a target system. The information about a system configuration designed for a specific system may be used by another system.

(3) Provision of a System Descriptive Format by Software Creator and System Designer

This application sets install method allows a software creator who creates each software package to describe a dependency about a dependent host concerned with a provided portion according to the predetermined configuration of the overall system and thereby provide the know-how about an installing destination of each software together with definition of the dependency. This makes it possible to clearly share definitions of the overall system, a definition of the dependencies of a software, and knowledge required for installing the software and eliminate the necessity of sharing the same know-how among executors of the foregoing operations unlike the prior arts.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a system configuration according to an embodiment of the present invention;

FIG. 2 is a block diagram showing an operation host included in the system configuration;

FIG. 3 is a block diagram showing an operation system included in the embodiment;

FIG. 4 is a view showing a structure of a software package included in the embodiment;

FIG. 5 is a view showing a structure of a list of softwares to be installed and a list of installed softwares;

FIG. 6 illustrates a schematic flow of installation;

FIG. 7 is a flowchart showing a process of installing a software package;

FIG. 8 is a sequence view showing a transfer of a message of a software management agent that is given an indication of installation by a software administrator;

FIG. 9 is a sequence view showing a transfer of a message of a software management agent that is given an indication of an install by another software management agent;

FIG. 10 is a view showing a structure of a message for requesting to solve a dependency; and

FIG. 11 is a view showing a structure of an expanded portion of a message for requesting to solve a dependency in the second embodiment of the invention.

### DESCRIPTION OF THE EMBODIMENTS

Hereafter, the first to the third embodiments of the present invention will be described.

[First Embodiment]

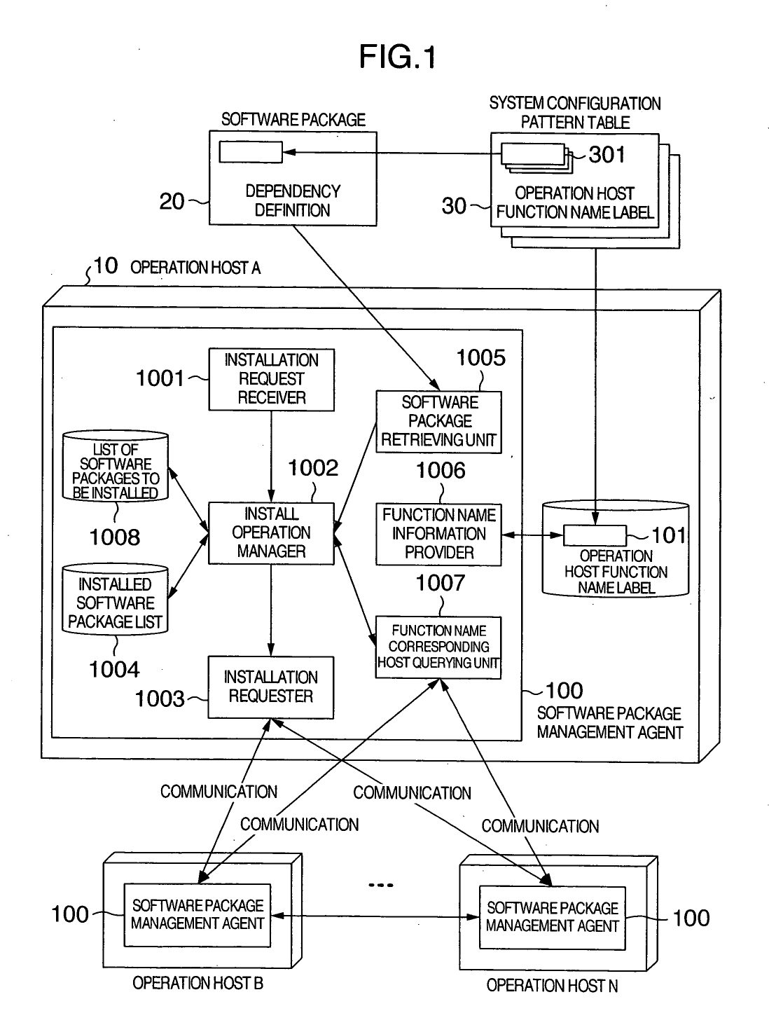

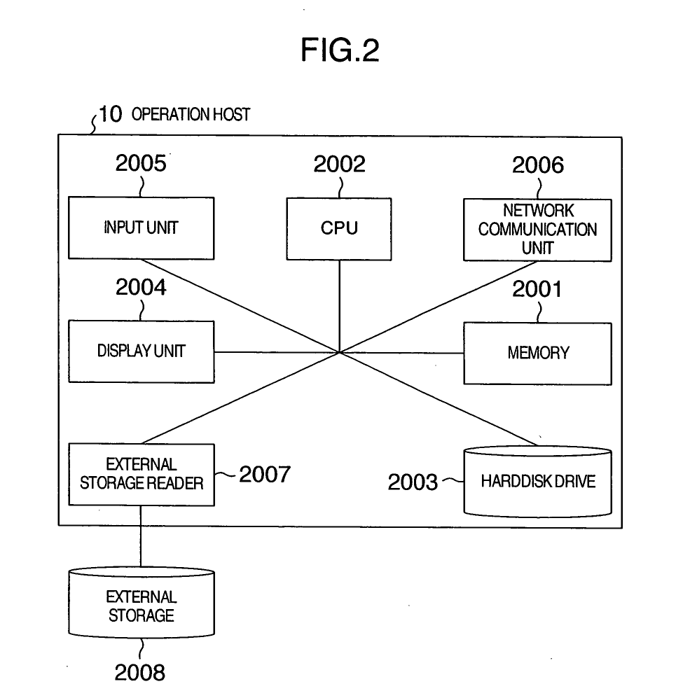

FIG. 1 shows a system configuration according to an embodiment of the present invention. This exemplary system configuration is composed of one or more operation hosts 10. An operation host 10 is a host used in a system that supplies a certain unique operation. The operation host 10 includes a software package management agent 100 and data on an operation host task label 101. Each operation host 10 (A, B, . . . , N) includes the software management agent 100. The communication between the software management agents 100 is executed to refer to each operation host task label 101. Each operation host 10 executes an installing process as checking a dependency of a software package 20 to be installed. The concrete functional configuration will be discussed below. Hereafter, a system composed of one or more operation hosts and that provides a unique operation is called an operation system. As shown in FIG. 2, the operation host 10 is configured to have a memory 2001, a CPU 2002, a harddisk drive 2003, a display device 2004, an input device 2005, a network communication unit 2006, and an external storage reader 2007. The external storage reader 2007 reads and obtains data from a storage or recording medium 2008 located outside the operation host.

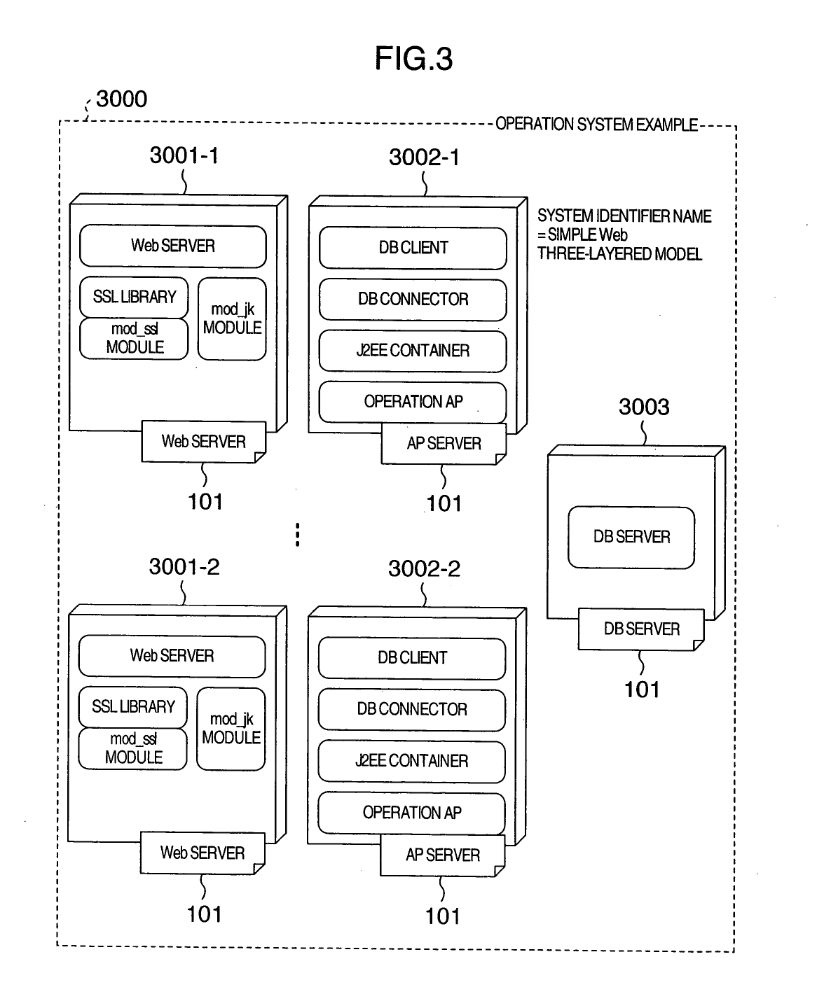

An example of the operation system is shown in FIG. 3. An operation system 3000 shown in FIG. 3 represents a cluster configuration of a typical Web system. The exemplary Web system is configured to have a plurality of Web servers 3001-1 to 3001-2, a plurality of application servers 3002-1 to 3002-2, and an operation host for a database server 3003. The Web servers 3001-1 and 3001-2 have the same configuration as each other. The application servers 3002-1 to 3002-2 also have the same configuration as each other. These servers have the same function in the operation system. In this embodiment, it is assumed that each software package to be installed to the operation host for fulfilling the same function has the same configuration. This embodiment provides the method of completing building of one or more operation hosts each having the same configuration at one work.

The operation host task label 101 is a character string or an ID for uniquely specifying a function of each operation host located in the operation system. For example, in the operation system 3000, a character string of “Web server” is assigned as the operation host task label to each of the Web servers 3001-1 and 3001-2 each having the same function.

Hereafter, the concrete function and the concrete information shown in FIG. 1 will be discussed below.

(Pattern Table 30 of System Configuration)

The pattern table 30 of the system configuration shown in FIG. 1 is a list of operation host task labels 301 used in one system. The content of each name label 301 is the same as the operation host function label 101 held by each operation host 10. The same operation host task labels are described on the system configuration pattern table 30 one by one. If a plurality of operation hosts 10 each having the same configuration are provided in the system, the same name label 301 is not described plural times. The system configuration pattern table 30 is made to be a list of the functions of the operation hosts configuring the system. The table 30 holds the information about features of the system configuration but does not have a description dependent on each system configuration such as a number of hosts and a name of hosts. For example, the pattern table of the foregoing operation system 3000 includes three operation host task labels of “Web server”, “AP server” and “DB server”.

(Summary of Agent)

As shown in FIG. 1, a software management agent 100 is located in all the operation hosts 10 located in the operation system. The software management agent 100 processes a software package 20 and manages an install of the software package 20. This software management agent 100 is a program that is run on the CPU 2002 located in the operation host 2000 shown in FIG. 2.

The agent 100 located in the operation system performs communications through a network so that data may be transferred between any two of the agents located in the system. Further, a software administrator allows the same data to be transmitted to the agent 100 located in each of the operation hosts 10 located in the operation system in parallel. This transmission is called a broadcasting communication.

Hereafter, description will be oriented to each component of the software management agent 100 shown in FIG. 1.

(Operation Host Task Label 101)

Each operation host 10 included in the operation system may have one operation host task label 101. This name label 101 serves to specify a function of the operation host located in the operation system. The name label 101 is stored as data in a harddisk drive 2003. If a certain operation host 10 has no name label 101, the operation host 10 is assigned as the “function unassigned state”. In this case, the operation host task label 301 is selected from the system configuration pattern table 30 and described in the operation function name label 101 of the function unassigned operation host 10.

Each software management agent 100 includes a function of retrieving and updating an operation host task label of the operation host 10 wherein the agent 100 is located. Each software management agent 100 includes function name information provider 1006 for retrieving the operation host task label 101 owned by itself, updating it and responding to a request for retrieving the label from another host and means 1007 for inquiring a function name corresponding host. The querying unit 1007 has a function of searching an operation host having the same function name as the specific function name (label). The querying unit 1007 serves to communicate with the function name information provider 1006 located in another software management agent 100 for referring to and changing the information about the operation host task label 101 of another operation host included in the operation system. The function name corresponding host querying unit 1007 and the function name information provider 1006 perform the following communications.

(Communication for Requesting to Obtain an Operation Host 10 that Holds a Specific Operation Host Task Label 101)

The function name corresponding host querying unit 1007 serves to transmit a request for retrieving a host that holds a specific operation host task label to the function name information provider 1006 operated in each of all the operation hosts located in the operation system through the effect of the broadcasting communication. This retrieving request includes the operation host task label (not shown) of the operation host to be obtained as a parameter. The function name information provider 1006 serves to receive this retrieving request and obtains the operation host task label to be obtained from that request. Then, it is determined if the operation host task label 101 assigned to the operation host where the function name information provider 1006 is located is the same as the operation host task label to be obtained. If yes, the host name of the operation host 10 where the function name information provider 1006 is located is sent back to the function name corresponding host querying unit 1007 of the software management agent 100 that has transmitted the retrieving request. The function name corresponding host querying unit 1007 treats a list of operation hosts (host names) sent back within a certain length of period as a list of operation hosts to which the same label as the “service host function name label” is assigned.

(Communication for Requesting to Inquire a Function Unassigned Operation Host)

A request for inquiring the function unassigned operation host is the same as the request issued in the case of requesting to obtain the host having the specific operation host task label excepting that an item of “service host function name label” in the foregoing retrieving request is blank. The function name information provider 1006, which receives data from the function name corresponding host querying unit 1007 through the effect of the broadcasting communication, sends back the host name of its own to the function name corresponding host querying unit 1007 located in the software management agent 100 that has transmitted the inquiring request if no operation host task label 101 is assigned to the operation host 10 where the providing means 1006 is located.

(Communication for Requesting to Set an Operation Host Task Label)

The function name corresponding querying unit 1007 transmits a request for setting a function name to the function name information provider 1006 of a specific operation host. This request includes data of “service host function name label” as a parameter. The providing means 1006 receives the request for setting a function name and changes the operation host task label 101 into a value of the requested operation host task label contained in the request only if the operation host task label of its own host is unassigned.

(Software Package Retrieving Unit 1005)

Given a software name for uniquely specifying a software package 20 to be installed, the software package retrieving unit 1005 obtains the requested software package 20. The retrieving method to be executed by the software package retrieving unit 1005 may be indicated as follows. Two or more of the following methods may be used at a time.

(Software Package Retrieving Method-1):

Obtention from the external storage 2008

The process is executed to obtain a list of file names of software packages 20 stored in the external storage 2008 shown in FIG. 2 and specify a storage location of a target software package 20 from the list. Then, a file image of the target software package 20 is obtained.

(Software Package Retrieving Method-2): Obtention from the internal harddisk drive 2003

File images of one or more software packages 20 are pre-stored in the harddisk drive 2003 located in the host as shown in FIG. 2. The software management agent 100 obtains a list of file names of the software packages 20 stored therein and then specifies a target software package 20 from the list. Then, an image of the target software package 20 is obtained.

(Software Package Retrieving Method-3): Obtention from an external repository (not shown)

A system is configured to store a plurality of file images of software packages 20 in the file sharing device (such as a HTTP server, an FTP server, a file sharing server or a NAS storage (not shown)), locate the file sharing device provided with a list of the stored file images and a unit of retrieving a file image in a place that is communicable with the operation host 10, and pre-store file images of one or more software packages 20. This is called an external repository. The software package retrieving unit 1005 includes an access protocol to one or more external repository and a storage area where a place of an access target on the network is described in the harddisk drive 2003 shown in FIG. 2. The software administrator of the operation system may edit data on the storage area for presetting the access protocol. The software management agent communicates with the specified external repository for retrieving a list of the file names of the software packages 20 and specifying a storage location of the target software package 20 from the list. Then, an image of the software package 20 is obtained.

(Software Package Retrieving Method-4): Obtention from the software management agent located in the operation system

The software management agent 100 transmits a request for retrieving a software package through the effect of the broadcasting communication. In receipt of the retrieving request, the software management agent 100 obtains the software package through the effect of one or more of the (software package retrieving method-1) to (software package retrieving method-4). If the obtention is successful, the obtained software package 20 is transmitted to the software management agent 100 having transmitted the retrieving request.

(Installation Requesting Unit 1003)

The installation requesting unit 1003 is communicating with a unit 1001 of receiving an installation request located in another software management agent through the use of each message to be discussed below. In the communication, the installation requesting unit 1003 requests to execute the install process and sends back the result to the unit 1001. The software management agent 100 of each operation host 10 transmits a message to the software management agent 100 of another operation host 10 through the effect of this communication and executes the install process.

(Message for Requesting to Solve Dependency: (not shown in FIG. 1))

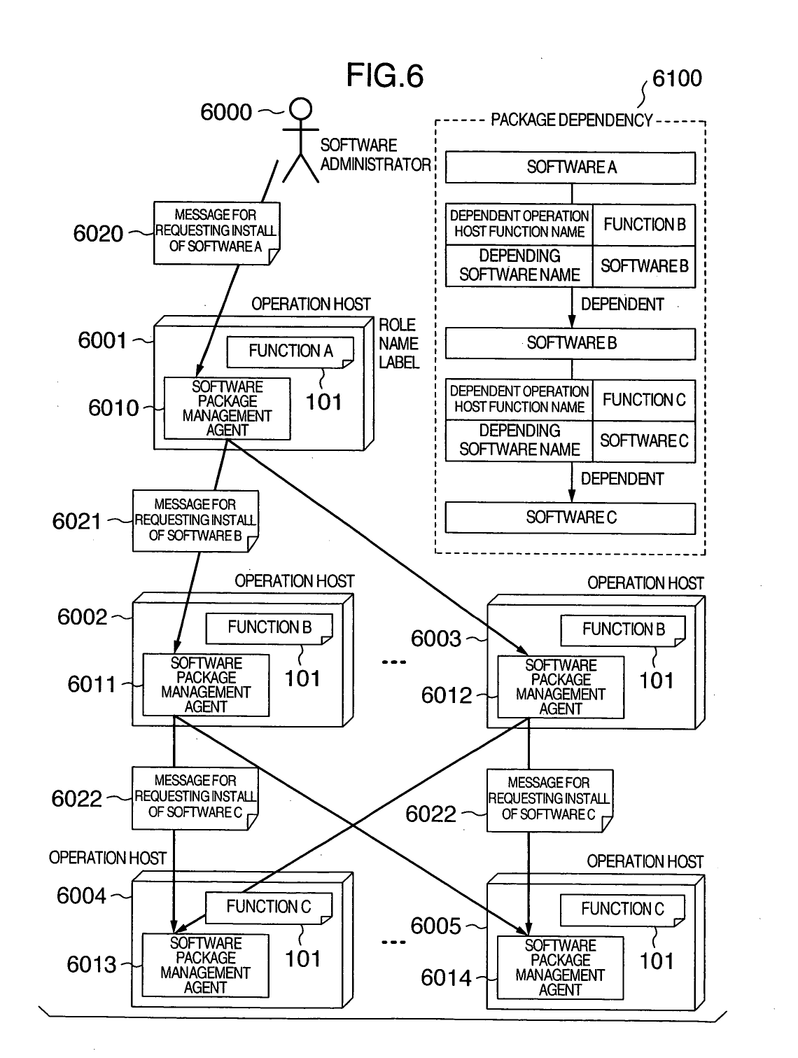

A software administrator specifies a software package 20 to be installed to the software management agent 100 for installing the software package 20. The software management agent 100 specifies the software package 20 to be installed to another software management agent 100 for installing the software package 20. This is a “message for requesting to install a software X” to be discussed with reference to FIG. 6. This is a trigger to the installing process. For this installing request, the software administrator transmits the message for requesting to solve a dependency to the software management agent 100 and the software management agent 100 transmits that message to another software management agent 100. In receipt of that requesting message, the software management agent 100 makes sure of the dependency and lists up the software packages 20 required for installing the specified software package 20. (Concretely, the required software package depends upon the install of the specified software package 20 and is to be installed before the specified software package 20). However, the install process is not executed. The details of the request will be discussed below.

(Install-Enable Message: (not Shown in FIG. 1))

In a case that the software management agent 100 lists up the software packages 20 dependent upon the software package 20 specified by the message for requesting to solve a dependency and makes sure that all the dependent software packages 20 are allowed to be installed, the install-enable message is sent back to the software management agent 100 that has transmitted the requesting message.

(Install Failure Message: (not Shown in FIG. 1))

In a case that the software management agent 100 lists up the software packages 20 depending upon the software package 20 specified by the message for requesting to solve a dependency and makes sure that one or more dependent software packages 20 cannot be installed, the install failure message is sent back to the software management agent 100 that has transmitted the requesting message.

(Install-Requesting Message: (not Shown in FIG. 1))

The software management agent 100 that has received the install-enable message operates to request another software management agent 100 (that is a source of transmitting the install-enable message) to actually install the software packages 20 listed in response to the foregoing message for requesting to solve a dependency.

(Install Success Message: (not Shown in FIG. 1))

In a case that the software management agent 100 receives the install-requesting message, executes the install program, and terminates the install program normally, the install success message is sent back to the software management agent 100 that has transmitted the message for requesting to solve a dependency.

(Install Management Function 1002)

The install management function 1002 shown in FIG. 1 treats the software package 20 as an install unit. The install management function 1002 receives the software package 20 and executes the install process.

(Software Package 20)

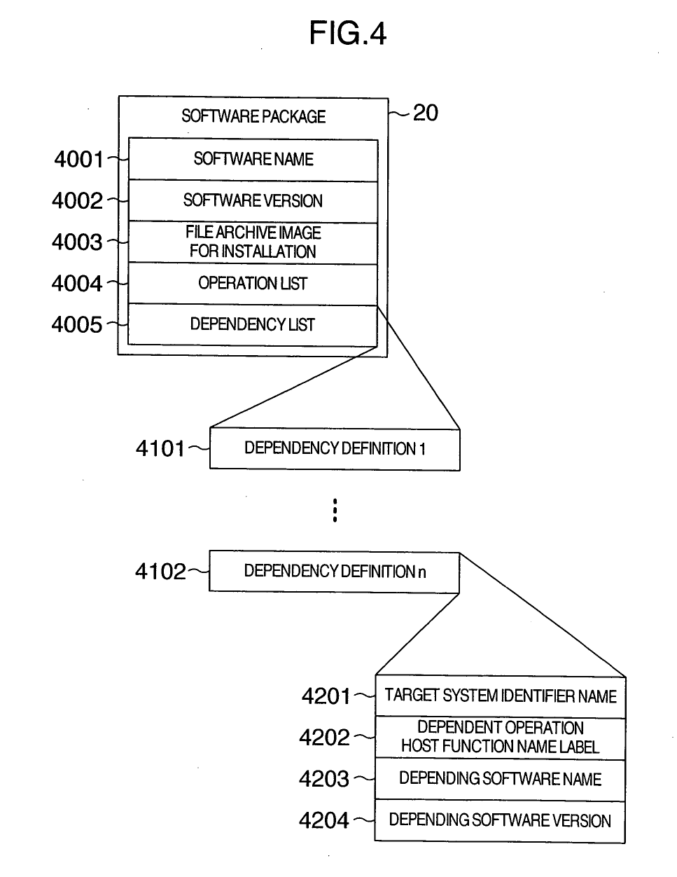

The software package 20 shown in FIG. 1 is a collection of data required for installing a software program. The software package 20 is stored in a file or the like. The software package 20 is also a unit of installing a software program. An example of a format of the software package 20 is illustrated in FIG. 4. The software package 20 is composed of a software name 4001, a software version 4002, an install file archive image 4003, an operation definition 4004, and a dependency definition list 4005.

The software name 4001 is composed of a character string or an ID for uniquely specifying the software package 20. The software version 4002 is an ID that represents a version of the software program. The software version is required to be computed for comparison between the new version and the old one. For example, the software version 4002 may be an integer value or a real number. The install file archive image 4003 is one or more file images required for installing the software package 20. The operation definition 4004 includes an install program name written therein. The install program name is executed in the case of installing the software package 20.

The dependency definition list 4005 is a list of dependency definitions 4101 to 4102 about the software package 20. The dependency definitions 4101 to 4102 each include a target system configuration name 4201, a dependent operation host task label 4202, a dependent software name 4203, and a dependent software version 4204.

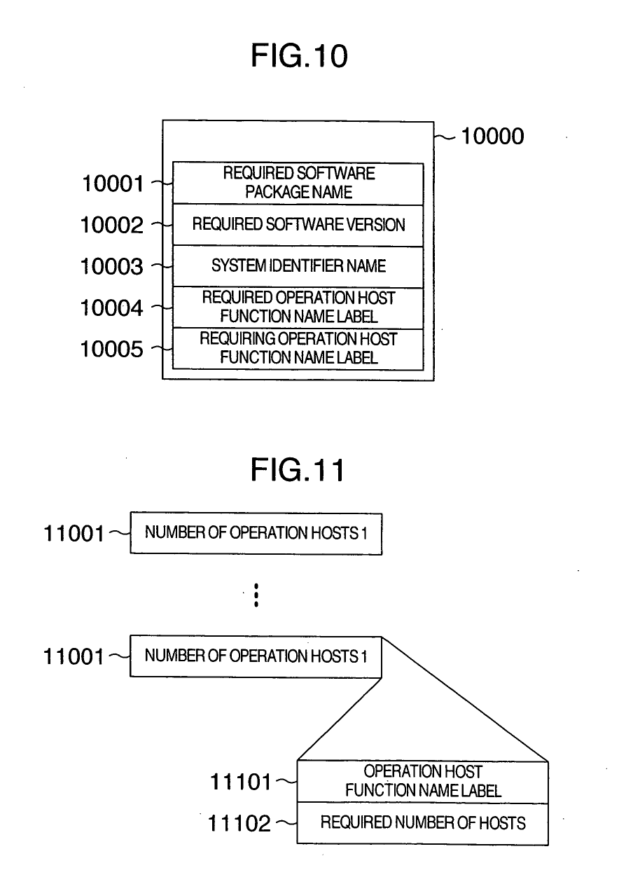

The target system configuration name is a character string or an ID for uniquely specifying a system configuration in which the dependency definitions 4101 to 4102 are valid. The dependency definitions 4101 to 4102 are valid only if the system configuration name 10003 (see FIG. 10) provided by an install indicator when installing a software program coincides with the target system configuration name 4201. If the dependency definition is invalid, that is, if the system configuration name 10003 given by the install indicator does not coincide with the target system configuration name 4201, the concerned dependency definitions 4101 to 4102 are not used. If the target system configuration name 4201 is blank, the dependency definitions 4101 to 4102 are always valid.

In the dependent software name 4203 are described the software names 4001 of one or more software programs functionally dependent upon the software package 20. In the dependent software version 4204 is described the software version 4002 required by the dependent software.

In the dependent operation host task label 4202 is described the operation host task label 101 assigned to the operation host 10 to which the dependent software is to be installed. All the operation hosts to which the dependent operation host task labels 4202 are assigned are specified as the destination operation hosts 10 to which the dependent software programs are to be installed.

(Installed Software List 1004)

The installed software list 1004 shown in FIG. 1 records information about the software packages 20 installed to the operation host 10 in which the concerned software management agent 100 is located.

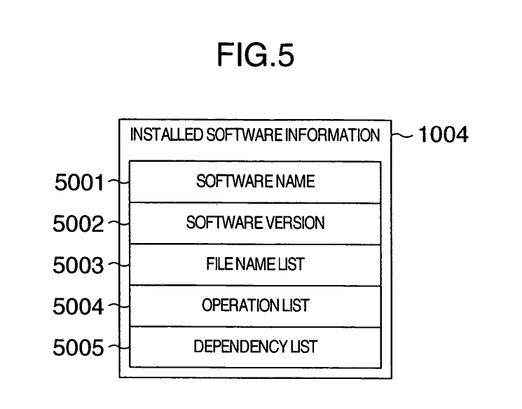

The installed software list 1004 has a composition as shown in FIG. 5, for example.

The installed software list 1004 is a list of installed software packages. The installed software information includes a software name 5001, a software version 5002, a file name list 5003, an operation definition 5004, and a dependency definition list 5005. In the software name 5001 is described a software name of an installed software package 20, in the software version 5002 is described a software version thereof, in the file name list 5003 is described a file name list included in the install file archive image 4003, in the operation definition 5004 is described an operation definition 4004 thereof, and in the dependency definition list is described a dependency definition 4005 thereof.

(List of Softwares To Be Installed 1008)

The list 1008 of softwares to be installed shown in FIG. 1 is a list of software packages 20 whose dependencies are being searched by the other software management agents 100 after the operation host 10 receives the request for solving a dependency. The configuration of the list of softwares to be installed may be the same as the list of installed softwares 1004. If the message for requesting to solve a dependency of a software package 20 is received by the function of receiving the install request shown in FIG. 1 and the software package is obtained by the software package retrieving unit 1005 shown in FIG. 1, the information about the software package 20 is described in the list of softwares to be installed 1008. Then, after the install of all the software packages 20 dependent upon that software package to the other operation hosts 10 are completed, that operation host 10 is inputted with the install requesting message. If the install of the software package 20 whose dependency is settled down becomes successful, the data described in the information 1008 about the software to be installed is shifted into the installed software list 1004.

(Installing Procedure)

Hereafter, the description will be oriented to the install of the software package 20 by the software management agent 100 shown in FIG. 1.

The install of the software package 20 is executed by a software administrator taking a charge of an operation system. The install of the software package 20 is divided into two processes, that is, assignment of the operation host task label 101 to the operation host 10 located in the operation system and execution of the actual install. Each process will be described below.

(Install Process-1 Assignment of the operation host task label 101 to the operation host 10)

The process is executed to cause the software administrator to assign the operation host task label 101 to each operation host 10 used in the operation system. The software administrator obtains the system configuration name 4201 and the list of the operation host task labels 301 used in the system by referring to the system configuration pattern table 30. Further, the software administrator selects the operation function name label 101 from the system configuration pattern table 30 and assigns the selected label 101 to each corresponding one of all the operation hosts 10 located in the operation system. This assignment is carried out by the following method, for example.

(Service Host Function Assigning Method-1)

The software administrator executes a program for indicating assignment of the operation host task label 101 on each operation host 10. The program is executed to prompt the software administrator to enter an operation host task label to be assigned to the operation host 10 and update the stored data into the entered label 101.

(Service Host Function Assigning Method-2)

The software administrator directly rewrites data of the operation host task label 101 with respect to each operation host 10.

(Service Host Function Assigning Method-3)

The process is executed to record a description of the operation host task label in the external recording device 2008 and transfer data read out of the external recording device 2008 by the operation host reader into the data stored in the operation host. The external recording device 2008 may be a dongle device, a USB memory or a bar code.

(Install Process-2 Execution of Install)

At first, the flow of the install will be schematically described. An example of a flow of a request for installing a software package will be illustrated in FIGS. 6, 8 and 9.

It is assumed that a package dependency 6100 as shown in FIG. 6 is defined. That is, a software A requires install of a software B into all the operation hosts 10 (6002 to 6003) having the operation host task label “function B”. The software B requires install of a software C into all the operation hosts 10 (6004 to 60005) having the operation host task label “function C”.

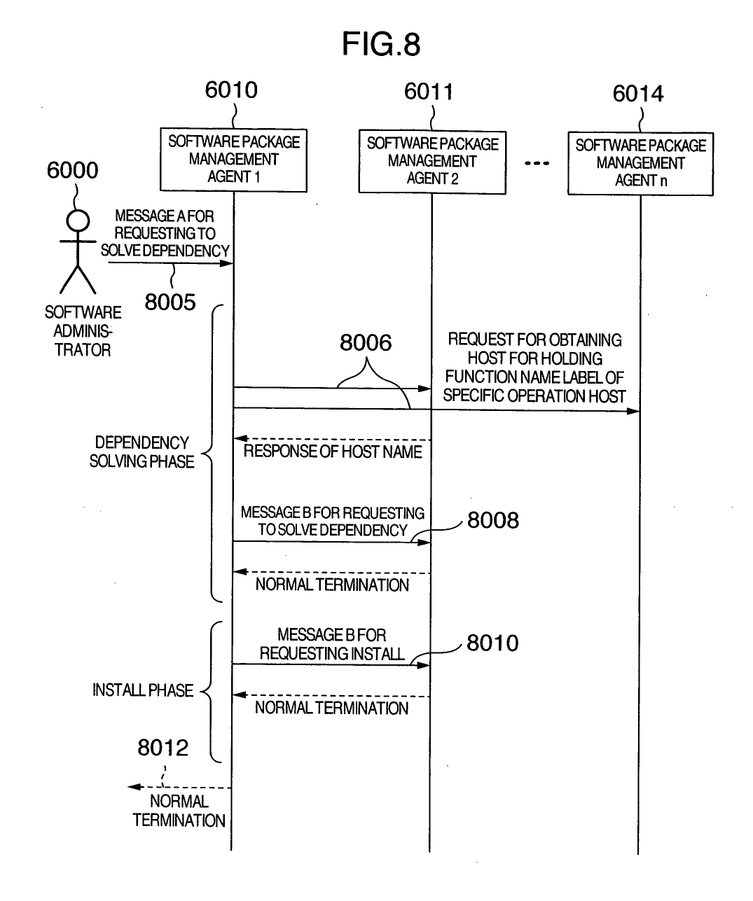

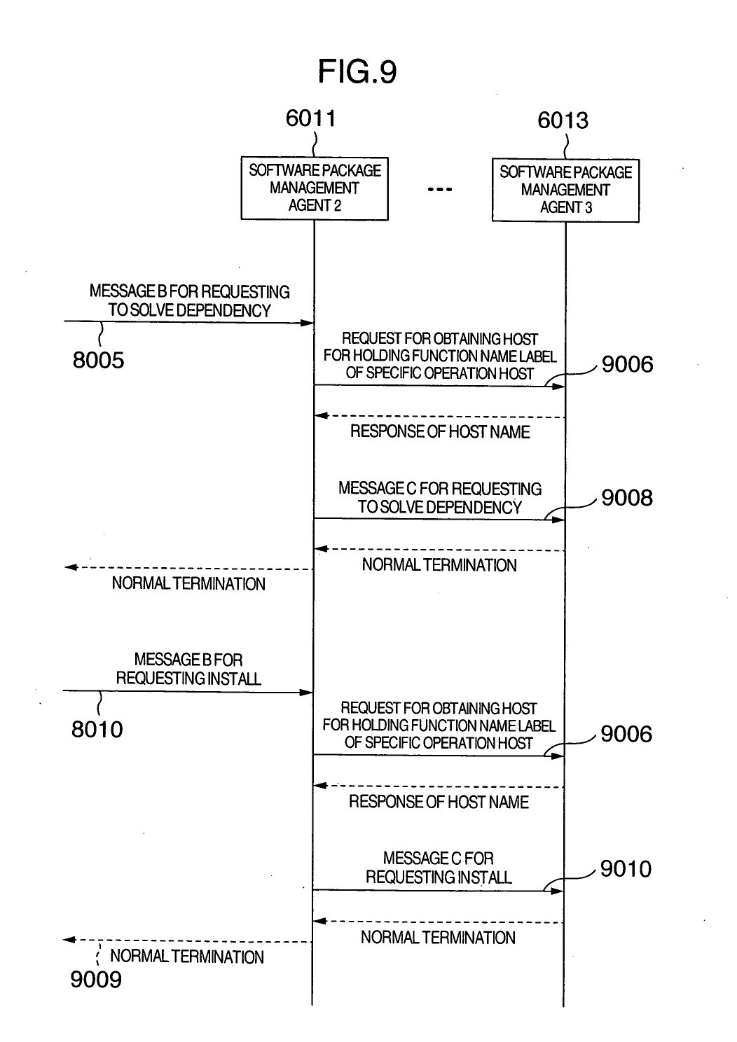

In this assumption, when a software administrator 6000 requires the install of the software A from the operation host 10 (6001), the way of propagating a message for requesting the install of the foregoing software X is illustrated in FIG. 6. FIGS. 8 and 9 are sequence views illustrating a flow of a message in the software management agent 6010 of the operation host 6001 and the software management agent 6011 of the operation host 6002.

The install process may be roughly divided into two phases, that is, a dependency solving phase and an install phase. In each phase, each software management agent sends a message for requesting an install to the other software management agents, collects the result of the message from the other agents, and sends back the result to the other agents.

FIG. 8 illustrates a process executed when the software management agent 6001 receives a message A for requesting to solve a dependency from the software administrator 6000. At first, the software management agent 6010 obtains the corresponding operation host 10 with the dependent operation host task label 4202 written as an install destination by referring to the dependency definition list 4005 written in the software package 20 to be installed (message in Step 8006). This obtention of the corresponding operation host 10 with the dependent operation host task label 4202 may be realized by comparing the dependent operation host task label 4202 with the operation host task label 101 held in each software management agent 100 having received the transferred message A and, if matched, retrieving a host name and a host ID of the operation host 10. In the embodiment shown in FIG. 8, it is assumed that the operation host functions are matched to each other in the software management agent 6011 but they are mismatched to each other in the software management agent 6011. A message B for requesting to solve a dependency is transmitted to the software management agent 6011 of the operation host 6002 obtained by the foregoing process (message in Step 8008). This message B is transmitted to all the software management agents 100 of the operation host 10 extracted when it is determined that both of the labels are matched in the comparison process of the foregoing operation host function so that the dependencies are settled down individually in the software management agents 100. The install of the multiple dependencies is recursively executed in the install phase to be discussed below. When the dependency concerned with the message B is settled down, the software management agent 6011 transmits an install-enable message to the software management agent 6010. (The agent 6011 terminates normally.) Afterwards, the process enters into the install phase, in which the install request means 1003 of the software management agent 6010 transmits a message B for requesting execution of the install to the install request receiving unit 1001 of the software management agent 6011. The install management function 1002 provided in the software management agent 6011 is executed to install the software package 20 concerned with the message B for requesting to solve a dependency and, if the install is completed, transmit the install-enable message to the software management agent 6010. (The agent 6011 terminates normally.) In a case that the software management agent 6010 makes sure that the normal termination about all the transmitted messages B, the agent 6010 installs the software package 20 concerned with the message A for requesting to solve a dependency and then terminates (Step 8012).

FIG. 9 illustrates the process to be executed when the software management agent 601 receives a message A for requesting to solve a dependency from another software management agent 6010 (see FIG. 6, not shown in FIG. 9). In this case, the software management agent 6011 solves the dependency by the same process as the agent shown in FIG. 8 (Steps 9006 and 9008). However, if the dependency is assured, the agent 6011 does not issue a request for executing the install but gives back a normal termination. The list 1008 of softwares to be installed is left, so that those softwares are to be installed. Then, when the message A for requesting to executing the install is received from another software management agent 6010, a message C for requesting to execute the install is transmitted to the software management agent 6013 having transmitted a message C for requesting to solve a dependency (Step 9010). The software management agent 6013 executes the install of the software package 20 about the message C for requesting to execute the install. The software management agent 6011 makes sure that the install is executed normally in response to the message C for requesting to execute the install, executes the process of installing the software package 20 about the message B for requesting to execute the install, and then gives back a normal termination to the software management agent 6010 (Step 9009). If a plurality of dependencies are provided, a plurality of messages for requesting to solve a dependency may be received from the other software management agents. Those messages are individually processed. Further, if the dependencies are made multiple to each other, the installs are processed by recursively executing the dependency solving phase and the install phase in the same method as the foregoing method shown in FIG. 8. While the normal termination is sent back after the receipt of the message for requesting to execute the install, no message for requesting to solve a dependency is received.

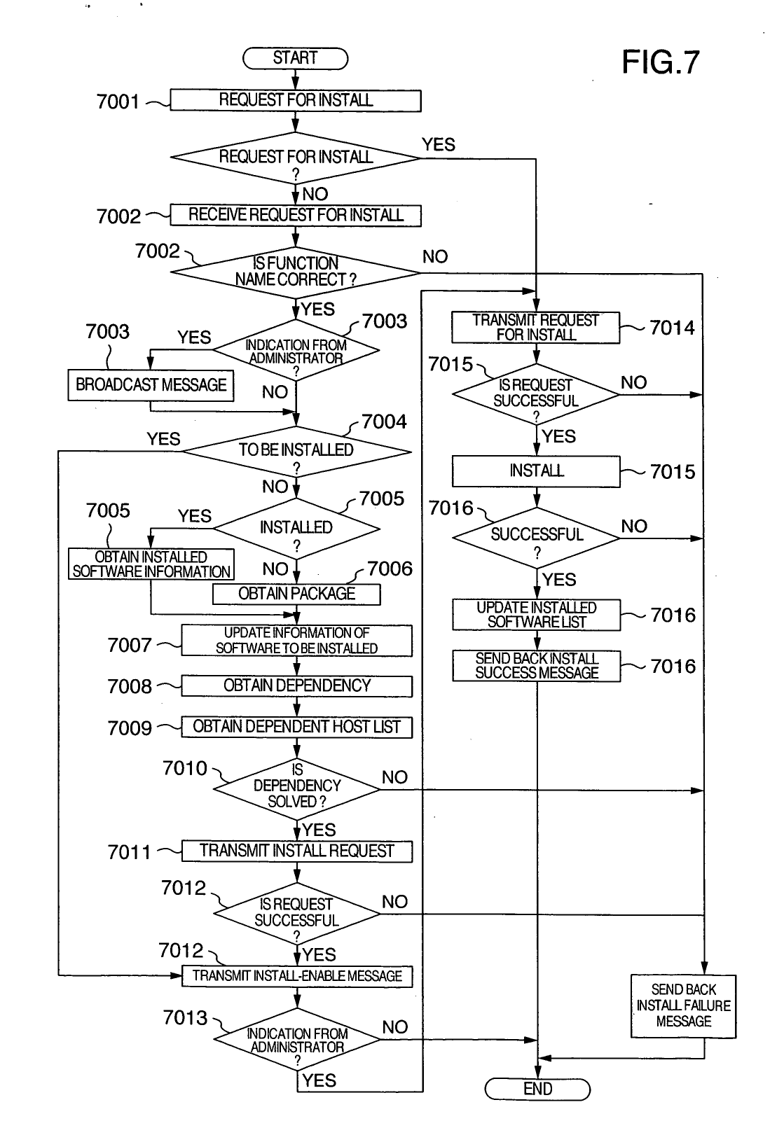

FIG. 7 illustrates the concrete process of installing a software package. The installing process follows the flowchart of FIG. 7. The process of Steps 7001 to 7013 corresponds to a dependency solving phase. The process of Steps 7013 to 7015 corresponds to an installing phase.

(Step 7001)

The process is executed to cause a software administrator to create a message for requesting a new software and transmit the request for installing a software to the software management agent in the operation host to which the software is to be installed. For creating the message for requesting a software may be used a program having an interface for prompting the software administrator to enter a character string in each of the items included in a message 10000 for requesting to solve a dependency as shown in FIG. 10.

A summary of the message 1000 for requesting to solve a dependency, which is a message for requesting a software, is shown in FIG. 10. This message 1000 includes a requesting software name 10001, a requesting software version 10002, a system configuration name 10003, a requesting operation host task label 10004, and a requesting operation host task label 10005. In the requesting software name 1001 is described a software name 4001 of a software package 20 to be installed. In the requesting software version 10002 is described a software version 4002 thereof. In the system configuration name 10003 is specified a system configuration name of the system configuration pattern table 30 to be referred in the (installing process-1). The requesting operation host task label 10004 represents an operation host task label 101 assigned to the operation host 10 for requesting the install. It indicates that it is necessary to install the software packages represented by the requesting software name 10001 into all the operation hosts having their operation host task labels 101 matched to the requesting operation host task labels 10004. In a case that the requesting operation host task label 10004 is blank, only the host that have received the message for requesting to solve a dependency is treated as the installing destination. In the requesting operation host task label 10005 is described the operation host task label 101 assigned to the operation host in which located is the software management agent 100 having transmitted the message for requesting to solve a dependency. If the software administrator creates the message for requesting to solve a dependency, the requesting operation host task label 10005 is blank. The transmission of the message for requesting to solve a dependency by the software administrator is executed through the effect of a program for communicating with the software management agent.

(Step 7002)

The software management agent makes sure of whether or not the requesting operation host task label 10004 written in the received message 10000 for requesting to solve a dependency is matched to the operation host task label 101 assigned to the operation host 10 in which the software management agent 100 is located. If not matched, the software management agent transmits the install failure message. If the requesting operation host-task label 1004 is blank, it means that the label 10004 is matched to all the operation function name labels.

(Step 7003)

The software management agent 100 receives the message 10000 for requesting to solve a dependency through the effect of the install request receiving unit 1001. Then, it is checked if the requesting operation host task label 10005 of the received message 10000 is blank. If the label 10005 is blank, that is, if the install request is directly received from the software administrator, the software management agent rewrites the requesting operation host task label 10005 of the received message 10000 into the data of the operation host task label 101 assigned to the operation host 10 in which the software management agent 100 is located, obtains a list of the operation hosts 10 each having the requesting operation host task label 10004 through the use of the function corresponding host querying unit 1007, and transmits the received message 10000 to the software management agent 100 of each operation host 10 included in the operation host list. If the requesting operation host task label 10004 is blank, the process of Step 7003 is not executed. If the process of Step 7003 is executed to cause the software administrator to issue an installing request to one host, the request may be transferred to the same kind of host.

(Step 7004)

The install management function 1002 shown in FIG. 1 searches if the software specified by the requesting software name 10001 and the requesting software version 10002 indicated by the message 10000 for requesting to solve a dependency is to be installed. In the list 1008 of the softwares to be installed as shown in FIG. 1, if the software name and the software version included in the list are matched to the requesting software name 10001 and the requesting software version 10002, it is determined that the software is to be installed. If the software is to be installed, the dependency is looped. The looped dependency is settled down. Hence, without executing the following process, the install-enable message is sent back to the requesting software management agent 100.

(Step 7005)

The install management function 1002 refers to the installed software list 1004 shown in FIG. 1 and searches if the software indicated by the requesting software name 10001 and the requesting software version 10002 included in the message 1000 has been installed by the same method as the process of Step 7004. If the concerned software has been already installed, the function 10002 obtains the information about the concerned installed software from the installed software list 1004.

(Step 7006)

If the software indicated by the requesting software name 10001 is not installed onto the operation host, the install management function 1002 obtains the software package 20 indicated by the requesting software name 10001 through the use of the software package retrieving unit 1005. If the software package retrieving unit 1005 fails in retrieving the software package 20 indicated by the requesting software name 10001, the software management agent transmits the install failure message to the install management agent 100 having transmitted the message 1000 or the software administrator.

(Step 7007)

The information about the software package 20 obtained in Step 7006 is added to the installed software list 1008.

(Step 7008)

The install management function 1002 obtains a list of dependency definitions from the installed software information or the software package obtained in Step 7005. Then, the function 1002 obtains a list of dependency definitions (4101 to 4102) that are valid in the system indicated by the system configuration name 10003 included in the message 10000 from each dependency definition list 4005 included in the obtained dependency definition list. The valid dependency definition indicates a dependency definition in which the target system configuration name 4201 of the dependency definition is matched to the system configuration name 10003 included in the message 10000.

(Step 7009)

The install management function 1002 determines the operation host on which each of the dependency definitions (4101 to 4102) being valid in the system, obtained in Step 7008, is dependent. Hereafter, this operation host is called a dependent host. The dependent host is determined according to the following process.

(Step 7009-1)

The install management function 1002 obtains the dependent host function name label 4202 from the dependency definitions 4101 to 4102.

(Step 7009-2)

If the label 4202 obtained in Step 7009-1 is blank, the source host is specified as the dependent host.

(Step 7009-3)

The install management function 1002 obtains a list of operation hosts 10 in which the operation host task label 101 is matched to the dependent operation host task label 4202 through the effect of the function name corresponding host querying unit 1007. If no operation host 10 in the operation system has the specified operation host task label 101, the querying unit 1007 gives back an empty list with no operation host. All the operation hosts 10 included in the list are specified as the dependent hosts.

(Step 7010)

If not a single operation host is included in the operation host list obtained in Step 7009-3, the software management agent 100 transmits the install failure message to the software management agent 100 having transmitted the install request.

(Step 7011)

About the software package defined in each of the dependency definitions (4101 to 4102) being valid in the system, which are obtained in Step 7008, a new dependency solving request message 10000 is created for one or more dependent hosts determined in Step 7009. Then, the software management agent 100 transmits the newly created dependency solving request message 10000 to the dependent host through the use of the install request means 1003, for requesting to solve the dependency. The system configuration name 10003 included in the message received in Step 7002 is transferred to the system configuration name 10003 of the dependency solving request message 10000. In the requesting operation host task label 10005 is described an operation host task label 101 assigned to the operation host 10 by the software management agent 100. In the request software name 10001, the request software version 10002, and the requesting operation host task label 10004 are respectively described the software name 4203, the software version 4204 and the dependent operation host task label 4202 defined in the dependency definitions 4101 to 4102.

(Step 7012)

The requesting software management agent 100 is waiting for a reply of the result from the requested software management agent 100 to each install request (dependency solving request message 10000) transmitted in Step 7011. In the install-requested operation host 10, the process of Steps 7002 to 7012 is recursively repeated. Then, the result is sent back from the requested software management agent 100. If the install-enable message is sent back for all the install requests, the requested software management agent 100 sends back the install-enable message to the requesting software management agent 100. If the install failure message has been sent back for one or more requests, after the replies of the results to all the requests are awaited, the install failure message is sent back.

The foregoing process makes it possible to realize the dependency solving phase shown in FIGS. 8 and 9.

(Step 7013)

If in the dependency solving request message 10000 received in Step 7002 the requesting operation host task label 10005 is blank, that is, the install request is received directly from the software administrator, the software management agent 100 transmits the install request message to the software management agents 100 of all the operation hosts 10 included in the dependent host list determined in Step 7009.

(Step 7014)

When the software management agent 100 receives the install request message through the effect of the install request receiving unit 1001, the software management agent 100 determines the dependent host from the software information registered in the list of softwares to be installed 1004 by the same method as that in Step 7009 and then transmits the install request message to the dependent host.

(Step 7015)

The install request unit 1003 is waiting for a reply of the result from the requested software management agent 100 with respect to each install request message. If the install failure message is sent back from one or more requested software management agents 100, after the replies of the results from all the requested software management agents 100 are awaited, the software management agent sends back the install failure message to the requesting software management agent 100.

(Step 7016)

If in Step 7015 the install successful message is sent back from all the requested software management agents 100, the requesting software management agent 100 obtains a list of operation softwares registered in the list 1008 of softwares to be installed and then executes the process of installing each software package 20 included in the software list. The install process is executed to search if each of the obtained softwares is included in the installed software list 1004. If it is included in the list 1004, the process of Step 7016 is terminated normally without performing the actual install process. If it is not included in the list 1004, that is, it is not still installed, with respect to the software package 20 obtained in Step 7006, the program written in the operation definition 4004 included in the software package 20 is executed. If the install process is terminated normally, the install management unit 1002 transfers the software information described in the list 1008 of softwares to be installed into the installed software list 1004. In succession, the function 1008 sends back the install successful message to the requesting software management agent 100 having transmitted the install request message. If the install program ends in failure, the install failure message is sent back to the requesting software management agent 100.

The foregoing process makes it possible to realize the install phase shown in FIGS. 8 and 9.

Hereafter, the effect of this embodiment will be described.

At first, since this embodiment uses the names for representing the functions of the install destination operations for the dependency definitions 4101 to 4102, this embodiment does not depend upon the proper information (such as a host name, a number of hosts, and a network address) to each system. Hence, the once described dependency may be reused in another system configured to have different host names and a different number of hosts.

In this embodiment, the system configuration pattern table 30 is used as the information that represents the configuration of the overall system. In this table 30, the system components are described with a character string that represents the function of the operation like the dependency definitions 4101 to 4102. Hence, this pattern table 30 may be reused.

As the works of definitions required for this embodiment, there are provided three works, that is, the definition of the system configuration pattern table 30, the dependency definition 4005 of the software, and the assignment of the operation host task label 101 to each operation host 10. Of these works, what is required to be grasped is only a value of the operation host task label 101. By sharing the three works of definitions as follows, it is possible to clearly separate the knowledge a person in charge of one work has to grasp from the other knowledge another person in charge of another work has to grasp.

The definition of the system configuration pattern table 30 is mainly executed by a system designer who configures the system. The system designer determines the role each host shares in consideration of the performance and the security of each host and the past experiments. The system designer is preferably requested to roughly grasp the software names but does not need to know the details of the dependency of each software package. Further, as described above, the system designer does not need to study the hardware configuration of each system when the designer designs the system.

The dependency definitions 4101 to 4102 are executed by the creator of each software product. It is considered that the creator has a knowledge of details of the dependency about the created software package. The creator defines the dependency based on his or her knowledge. At this time, the person who defines the dependency grasps the operation host task label of the host in which the software product is to be used by referring to the system configuration pattern table 30. The software creator is just requested to refer to the label of the system. The creator does not need to design the portion with which the target product does not concern.

The assignment of the operation host task label 101 is executed by the software administrator. The software administrator needs to grasp a list of hardware resources (such as the host) to be used by the system, the operation host task label 301, and the system configuration name by referring to the system configuration pattern table 30. However, the software administrator does not need to grasp the knowledge for designing the system configuration and about the detailed dependency among the software packages.

Lastly, when executing the install of the software package, the process is executed to automatically obtain the real host corresponding with the operation host function name and then to determine the destination host to which the software package is to be installed. Hence, the software administrator does not need to specify the installing destination to each software package.

As set forth above, the present embodiment makes it possible to improve reusability, facilitate sharing of works, and reduce the number of works in installing a software package, thereby making the software management easier.

[Second Embodiment]

In the operation of searching the operation host 10 to which the dependent operation host task label 101 is assigned in Step 7009 of the install process according to the first embodiment, unlike the first embodiment, if no corresponding operation host 10 with the dependent operation host task label 4202 is found, the operation of the second embodiment is executed not to give back an error but to dynamically create the operation host 10 to which the dependent operation host task label 4202 is newly assigned as the operation host task label 101 through the following process.

The following description concerns with the realizing means.

Step 7001 of the first embodiment is changed into the following step 7101.

(Step 7101)

The process is executed to change a format of the software request message and to add the content as shown in FIG. 11, for example. A number of operation hosts 11001 indicates the number of operation hosts represented by a specific operation host task label. In the operation host number are described an operation host task label 11101 and a requested number of hosts 11102. In the operation host task label 11101 is described the operation host task label 301 included in the system configuration pattern table 30. In the requested host number 11102 is described the requested number of operation hosts to which the value indicated by the operation host task label 1101 is assigned as the operation host function name 101. The operation host number 11001 indicates that the operation system needs the number denoted by 11102 of the operation hosts each having the operation host function name denoted by 11101.

Step 7009 of the first embodiment is changed into the following step 7109.

(Step 7109-1)

The install management function 1002 obtains the dependent operation host task label 4202 from the dependency definitions 4101 to 4102.

(Step 7109-2)

If the dependent operation host task label 4202 obtained in Step 7109-1 is blank, the source host is specified as the dependent operation host.

(Step 7109-3)

The function name corresponding host querying unit 1007 obtains a list 10 of operation hosts having the operation host task label 101 matched to the dependent operation host task label 4202 obtained in Step 7109-1.

(Step 7109-4)

If the number of operation hosts included in the operation host list obtained in Step 7109-3 is smaller than the required number of hosts 11102 specified by the number of operation hosts 11001 included in the message for requesting to solve a dependency, the function corresponding host querying unit 1007 obtains the list of operation hosts “in the function-unassigned state” and selects one operation host 10 from the obtained list of operation hosts “in the function-unassigned state” at random or according to the predetermined policy such as in the first-come first-served manner. If the total number of the number of operation hosts obtained in Step 7109-3 and the number of the hosts in the function-unassigned state does not reach the required number of hosts, the querying unit 1007 sends back the install failure message to the requesting software management agent 100. In the case of retrieving the necessary number of hosts in the function-unassigned state, the querying unit 1007 sends out a request for setting an operation host task label having the dependent operation host task label 4202 as a parameter to the selected operation host in the function-unassigned state.

Further, each software management agent 100 copies the operation host number 11001 included in the received message for requesting to solve a dependency onto the dependency solving request message to be transmitted and then transmits the message.

The effect of the second embodiment will be described. In the (install process-1) of the first embodiment, the software administrator assigns the operation host task label to all the operation hosts. However, the processing is made complicated in the case that all the operation hosts have the substantially same performance and thus the assignment of each function to the corresponding operation host is not required to be designed. In the second embodiment, however, if the assignment may be executed by the mechanical operation without having to design the assigning process, the process of assigning the operation host task label to the operation host is eliminated from the work of the software administrator, for simplifying the administrator's work.

[Third Embodiment]

This embodiment prepares a software package having the system configuration information in the system of the first or the second embodiment. This will be called a system package. The software package configuration of the system package includes information expanded for another software package 20. For example, in a software package 20 are described a system configuration name and an operation host task label assigned to an operation host to which the software package itself is to be installed.

A software administrator specifies an install of the system package 20 when it is to be installed and transmits a message for requesting to solve a dependency. The system configuration name and the operation host task label may be eliminated from that message. If the software management agent is inputted with a request for installing the system package, the agent obtains the system package and then the system configuration name and the operation host task label from the obtained system package, for utilizing them.

The system may be arranged to prepare a host with the software package stored in the harddisk drive and to determine a host function through a toggle switch located outside. The use of this arrangement allows one general-purpose server to promptly specify the server function so that the server may be set up to the usable state.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A software management system composed of a plurality of hosts and for managing a process of installing a software program, each of said hosts comprising:
a storage unit for holding information that represents a function of a certain host;
a processing unit for specifying one or more hosts on which said certain host depends through use of dependency information and information that represents a function of said concerned host, said dependency information being included in said software program to be installed; and
an operational processing unit for executing a process of installing said software program into said host after completion of installing a software program into said specified dependent host.

2. A software management system composed of a plurality of hosts and for managing a process of installing a software program, each of said hosts comprising:
a storage unit for holding information that represents a function of a host;
a functional unit for specifying one or more hosts on which said certain host depend and outputting an indication of making sure of a dependency through use of dependency information and information that represents a function of said certain host, said dependency information being included in said software program to be installed; and
a management agent having a function of installing said software program into said certain host after completion of installing said specified dependent host.

3. A software management system composed of a plurality of hosts and for managing a process of installing a software program, comprising:
a unit for holding information about one or more hosts on which a certain host depends as dependency information through use of information that represents a function of said certain host; and
a unit for dynamically determining a destination host to which said software program is to be installed through use of said information that represents a function of said certain host and information that represents a function assigned to each host in advance when installing said software program.

4. The software management system according to claim 2, wherein said management agents included in said hosts respectively are operated independently of each other and said installing process is proceeded by recursively repeating direct issuance of a request from one management agent to another one.

5. The software management system according to claim 1, wherein if no destination host to which said software program is to be installed cannot be determined, said concerned host specifies a host having a replaceable condition and dynamically changes a function shared by said concerned host in said system management system.

6. The software management system according to claim 2, wherein if no destination host to which said software program is to be installed cannot be determined, said concerned host specifies a host having a replaceable condition and dynamically changes a function shared by said concerned host in said system management system.

7. The software management system according to claim 3, wherein if no destination host to which said software program is to be installed cannot be determined, said concerned host specifies a host having a replaceable condition and dynamically changes a function shared by said concerned host in said system management system.

8. The software management system according to claim 1, wherein each of said hosts reads information that represents a function of said concerned host from an external reading unit and supplies said software management system with said read information.

9. The software management system according to claim 2, wherein each of said hosts reads information that represents a function of said concerned host from an external reading unit and supplies said software management system with said read information.

10. The software management system according to claim 3, wherein each of said hosts reads information that represents a function of said concerned host from an external reading unit and supplies said software management system with said read information.

11. The software management system according to claim 1, wherein said dependency information includes a condition in which said dependency information is valid and one software package includes dependencies under a plurality of circumstances.

12. The software management system according to claim 2, wherein said dependency information includes a condition in which said dependency information is valid and one software package includes dependencies under a plurality of circumstances.

13. The software management system according to claim 3, wherein said dependency information includes a condition in which said dependency information is valid and one software package includes dependencies under a plurality of circumstances.

14. The software management system according to claim 1, wherein information for identifying a configuration of a target system to which a software program is to be installed is included in a package of said software program.

15. The software management system according to claim 2, wherein information for identifying a configuration of a target system to which a software program is to be installed is included in a package of said software program.

16. The software management system according to claim 3, wherein information for identifying a configuration of a target system to which a software program is to be installed is included in a package of said software program.

17. A method of installing a software program through the effect of a system composed of a plurality of hosts, comprising the steps of:
reading information that represents a function of a certain host from a storage unit;
specifying one or more hosts on which said certain host depends through use of dependency information included in the software program to be installed and information that represents a function of said certain host; and
executing a process of installing said software program through an effect of an operational processing unit after completion of installing said software program in said one or more hosts upon which said certain host depends.

18. The method of installing a software program according to claim 17, further comprising the step of outputting an indication of making sure of said dependency information after said second step.
